(19) United States
(12) Patent Application Publication
(10) Pub. No.: US 2023/0161324 A1
(43) Pub. Date: May 25, 2023

(54) ELECTRONIC APPARATUS FOR PERFORMING HEATING CONTROL AND CONTROL METHOD THEREFOR

(71) Applicant: SAMSUNG ELECTRONICS CO., LTD., Gyeonggi-do (KR)

(72) Inventors: Kwanjin JUNG, Gyeonggi-do (KR); Hyunchul SEOK, Gyeonggi-do (KR); Byungsoo Kwon, Gyeonggi-do (KR); Junhwa SEO, Gyeonggi-do (KR); Youngcheol SIN, Gyeonggi-do (KR); Sunkwang LEE, Gyeonggi-do (KR); Daehyun CHO, Gyeonggi-do (KR); Wonseo CHOI, Gyeonggi-do (KR)

(21) Appl. No.: 17/432,410

(22) PCT Filed: Feb. 18, 2020
(86) PCT No.: PCT/KR2020/002332

§ 371 Date: Feb. 1, 2023

(30) Foreign Application Priority Data
Feb. 19, 2019 (KR) 10-2019-0019509

(51) Int. Cl. G05B 19/4155

(52) U.S. Cl. CPC G05B 19/4155; G05B 2219/50333

(57) ABSTRACT

An electronic apparatus according to various embodiments comprises: at least one processor; and a memory storing a first table and a second table which are associated with a value associated with a performance of an operation of the at least one processor and a maximum allowable value of a clock, wherein a maximum allowable value in the first table corresponding to at least some of values associated with the performance of the operation of the at least one processor is different from a maximum allowable value in the second table corresponding to the at least some of the values associated with the performance, wherein the at least one processor may verify that an attribute of an application being executed by the at least one processor is any one of a first attribute or a second attribute, control the maximum allowable value of the clock where the at least one processor operates on the basis of the first table when the attribute of the application is the first attribute, and control the maximum allowable value of the clock where the at least one processor operates on the basis of the second table when the attribute of the application is the second attribute. Other various embodiments can be provided.

### CROSS-REFERENCE TO RELATED APPLICATION(S)

This application is a Continuation application of PCT International Application No. PCT/KR2020/002332, which was filed on Feb. 18, 2020, and claims priority to Korean Patent Application No. 10-2019-0019509, which was filed on Feb. 19, 2019, the content of each of which is incorporated herein by reference.

### BACKGROUND

### 1. Field

The present disclosure relates generally to an electronic apparatus for performing heat generation control and a control method therefor.

### 2. Description of Related Art

When a processor of an electronic apparatus executes an application or a task, heat is generated from the processor. There is an increasing number of applications entailing significant power consumption of a processor, such as gaming applications. When an application causing high power consumption of a processor is executed, excessive heat may be generated in an electronic apparatus. For example, when an application that consumes a lot of power is executed, the processor may require a high clock speed value. When the application is driven using a relatively high-frequency clock, a relatively large amount of heat may be generated in the processor. The electronic apparatus may control the clock of the processor to prevent excessive heat generation.

Accordingly, an electronic apparatus may configure a maximum allowable clock speed to prevent excessive heat generation. The electronic apparatus may control a clock generation circuit not to exceed the maximum allowable clock speed, thereby preventing excessive heat generation. However, in controlling heat generation in the electronic apparatus, when uniform heat generation control is performed without considering the structure (or attribute) of an executed application or task, deterioration in performance may occur if the same amount of power is used, thus reducing efficiency.

### SUMMARY

The present disclosure has been made to address the above-mentioned problems and disadvantages, and to provide at least the advantages described below.

An electronic apparatus according to various embodiment may include: at least one processor; and a memory storing a first table and a second table that are associated with performance-related values and a maximum allowable value of a clock on which the at least one processor operates, wherein a maximum allowable value in the first table corresponding to at least some of the performance-related values on which the at least one processor operates is different from a maximum allowable value in the second table corresponding to the at least some of the performance-related values, wherein the at least one processor may: identify that an attribute of an application being executed by the at least one processor is either a first attribute or a second attribute; control the maximum allowable value of the clock on which the at least one processor operates, based on the first table when the attribute of the application is the first attribute; and control the maximum allowable value of the clock on which the at least one processor operates, based on the second table when the attribute of the application is the second attribute.

A method for performing heat generation control by an electronic apparatus may include: storing a first table and a second table that are associated with performance-related values and a maximum allowable value of a clock on which at least one processor of the electronic apparatus operates, wherein a maximum allowable value in the first table corresponding to at least some of the performance-related values on which the at least one processor operates is different from a maximum allowable value in the second table corresponding to the at least some of the performance-related values; identifying that an attribute of an application being executed by the at least one processor is either a first attribute or a second attribute; controlling the maximum allowable value of the clock on which the at least one processor operates, based on the first table when the attribute of the application is the first attribute; and controlling the maximum allowable value of the clock on which the at least one processor operates, based on the second table when the attribute of the application is the second attribute.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a network environment including an electronic device, according to various embodiments;

FIG. 2 is a block diagram illustrating a program, according to an embodiment;

FIG. 3 is a flowchart showing that an electronic apparatus controls a maximum allowable value of a clock on which a processor operates in accordance with an attribute of an application, according to an embodiment;

FIG. 4 illustrates a configuration in which a maximum allowable value of a clock of a processor is determined for each cluster, according to an embodiment;

FIG. 5 illustrates a table of maximum allowable values of a clock on which a plurality of clusters operates, according to an embodiment;

FIG. 6 is a flowchart illustrating a configuration in which an electronic apparatus controls a maximum allowable value of a clock of a processor in accordance with attributes of a plurality of applications, according to an embodiment;

FIG. 7 illustrates a configuration in which an electronic apparatus controls a maximum allowable value of a clock of a processor in accordance with attributes of a plurality of applications, according to an embodiment;

FIG. 8 is a block diagram illustrating a configuration in which heat generation control of a processor is performed in an application level, a framework level, and a kernel level, according to an embodiment;

FIG. 9A is a flowchart showing that an electronic apparatus controls a maximum allowable value of a clock on which a processor operates in accordance with an attribute of an application, according to an embodiment;

FIG. 9B is a flowchart showing that an electronic apparatus determines a maximum allowable value of a clock on which a processor operates, based on attributes of a plurality of tasks, according to an embodiment;

FIG. 10 illustrates a configuration in which an electronic apparatus determines a maximum allowable value of a clock on which a processor operates, based on attributes of a plurality of tasks, according to an embodiment;

FIG. 11 is a flowchart illustrating a configuration in which an electronic apparatus controls the range of a voltage applied to a processor, based on an attribute of a task, according to an embodiment;

FIG. 12 illustrates a table used by an electronic apparatus to control the range of a voltage applied to a processor, based on an attribute of a task, according to an embodiment; and

FIG. 13 illustrates a configuration in which heat generation control of an electronic apparatus is performed in middleware and kernel levels, according to an embodiment.

### DETAILED DESCRIPTION

Various embodiments of the present disclosure are described with reference to the accompanying drawings. However, various embodiments of the present disclosure are not limited to particular embodiments, and it should be understood that modifications, equivalents, and/or alternatives of the embodiments described herein can be variously made. With regard to description of drawings, similar components may be marked by similar reference numerals.

According to various embodiments, there may be provided an electronic apparatus and a control method thereof for controlling a clock on which a processor operates in consideration of the instruction set architecture of an application or task. The electronic apparatus may control heat generation, thereby improving the processing performance of the processor.

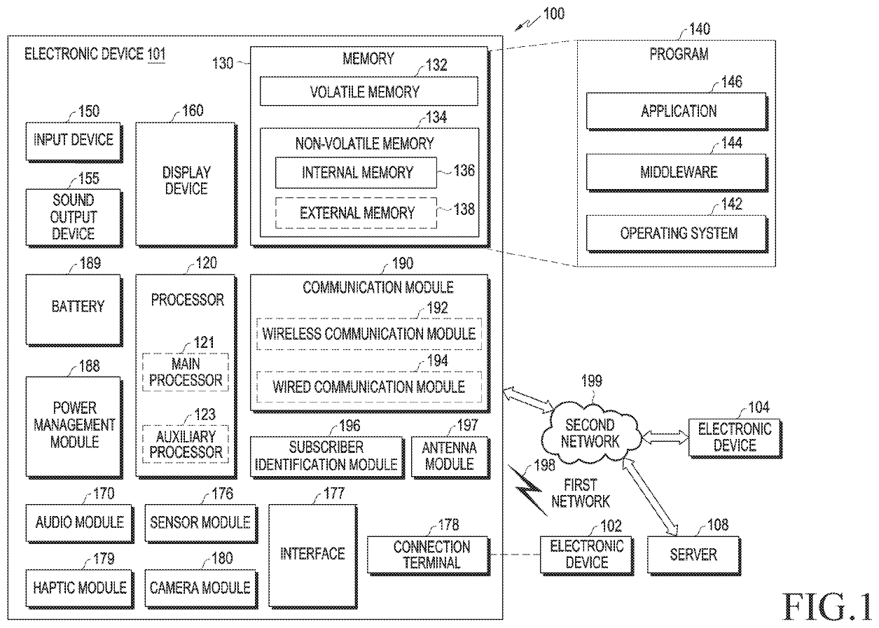

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control, for example, at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active (e.g., executing an application) state. According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by a component (e.g., the processor 120) of the electronic device 101, from the outside (e.g., a user) of the electronic device 101. The input device 150 may include, for example, a microphone, a mouse, a keyboard, or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing record, and the receiver may be used for incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or an external electronic device (e.g., an electronic device 102 (e.g., a speaker or a headphone)) directly or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image and moving images. According to an embodiment, the camera module 180 may include one or more lenses, image sensors, image signal processors (ISPs), or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors (CPs) that are operable independently from the processor 120 (e.g., the application processor (AP)) and support a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to an embodiment, the antenna module may include an antenna including a radiating element composed of a conductive material or a conductive pattern formed in or on a substrate (e.g., PCB). According to an embodiment, the antenna module 197 may include a plurality of antennas. In such a case, at least one antenna appropriate for a communication scheme used in the communication network, such as the first network 198 or the second network 199, may be selected, for example, by the communication module 190 from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

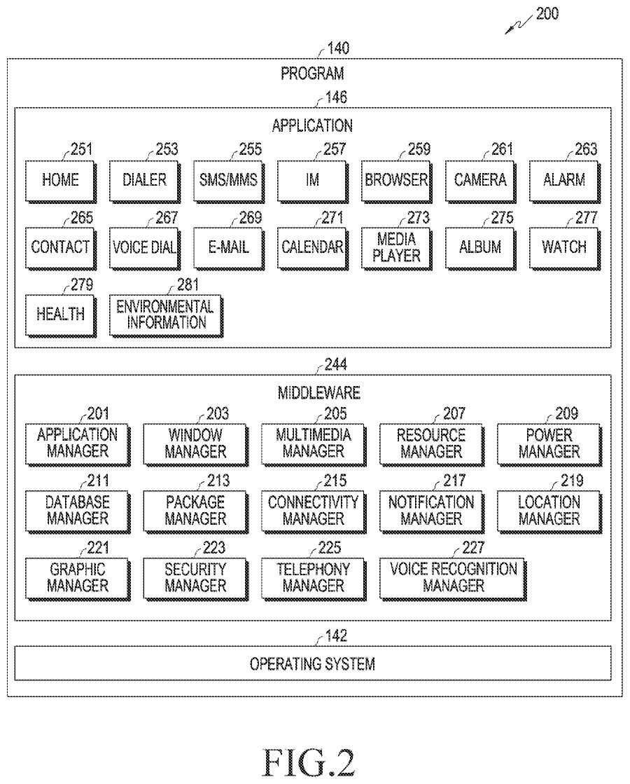

FIG. 2 is a block diagram 200 illustrating a program 140, according to an embodiment.

Referring to FIG. 2, the program 140 includes an OS 142 that controls one or more resources of an electronic apparatus 101, middleware 144, or an application 146 that is executable on the OS 142. The OS 142 may include, for example, Android™, iOS™, Windows™, Symbian™, Tizen™, or Bada™. At least part of the program 140 may be preloaded onto the electronic apparatus 101 at the time of manufacture, or may be downloaded or updated by a user from an external electronic apparatus at the time of use.

The OS 142 may control management (e.g., allocation or recovery) of one or more system resources (e.g., a process, a memory, or power) of the electronic apparatus 101. The OS 142 may, additionally or alternatively, include one or more driver programs to drive other hardware devices of the electronic apparatus 101. The hardware devices may include at least one of an input device 150, a sound output device 155, a display device 160, an audio module 170, a sensor module 176, an interface 177, a haptic module 179, a camera module 180, a power management module 188, a battery 189, a communication module 190, a subscriber identity module 196, or an antenna module 197.

The middleware 144 may provide various functions to the application 146 so that the application 146 may use a function or information provided by one or more resources of the electronic apparatus 101. The middleware 144 may include an application manager 201, a window manager 203, a multimedia manager 205, a resource manager 207, a power manager 209, a database manager 211, a package manager 213, a connectivity manager 215, a notification manager 217, a location manager 219, a graphic manager 221, a security manager 223, a telephony manager 225, or a voice recognition manager 227.

The application manger 201 may manage the life cycle of the application 146. The window manager 203 may manage one or more graphical user interface (GUI) resources used for a screen. The multimedia manager 205 may identify one or more formats necessary to play media files, and may encode or decode a corresponding media file among the media files using a codec suitable for a selected format. The resource manager 207 may manage a source code of the application 146 or a memory space of the memory 130. The power manager 209 may manage the capacity, temperature, or power of a battery 189 and may provide information on power necessary for the operation of the electronic apparatus 101 using corresponding information thereamong. The power manager 209 may interoperate with a basic input/output system (BIOS) of the electronic apparatus 101.

The database manager 211 may generate, retrieve, or change a database to be used by the application 146. The package manager 213 may install or update an application distributed in the form of a package file. The connectivity manager 215 may manage wireless connectivity or direct connectivity between the electronic apparatus 101 and an external electronic apparatus. The notification manager 217 may provide a function of reporting the occurrence of a designated event (e.g., an incoming call, a message, or an alarm) to a user. The location manager 219 may manage position information on the electronic apparatus 101. The graphic manager 221 may manage one or more graphic effects to be provided for a user or a user interface related to the graphic effects.

The security manager 223 may provide system security or user authentication. The telephony manager 225 may manage a voice or video call function provided by the electronic apparatus 101. The voice recognition manager 227 may transmit voice data on a user, to a server 108 and may receive, from the server 108, a command corresponding to a function to be performed in the electronic apparatus 101 at least partly based on the voice data or text data converted at least partly based on the voice data. The middleware 144 may dynamically delete some of the existing components or may add new components. At least part of the middleware 144 may be included as a part of the OS 142 or may be configured as software separate from the OS 142.

The application 146 may include one or more applications for a home screen 251, a dialer 253, a short message service (SMS)/multimedia message service (MMS) 255, instant messaging (IM) 257, a browser 259, a camera 261, an alarm 263, an address book 265, voice dial 267, email 269, a calendar 271, a media player 273, an album 275, a clock 277, health care 279 (e.g., for measuring exercising or biometric information, such as blood sugar), and environmental data 281 (e.g., measuring atmospheric pressure, humidity, or temperature data).

The application 146 may further include an information exchange application that supports information exchange between the electronic apparatus 101 and an external electronic apparatus. The information exchange application may include a notification relay application configured to relay specific information (e.g., a call, a message, or an alarm) to an external electronic apparatus or a device management application configured to manage an external electronic apparatus. The notification relay application may transmit, to an external electronic apparatus, notification information corresponding to a designated event (e.g., receipt of mail) occurring in another application (e.g., the email application 269) of the electronic apparatus 101. Additionally or alternatively, the notification relay application may receive notification information from an external electronic apparatus and may provide the notification information to the user of the electronic apparatus 101.

The device management application may control power (e.g., turning on or turning off) or a function (e.g., the brightness, resolution, or focus of the display device 160 or the camera module 180) of an external electronic apparatus communicating with the electronic apparatus 101 or some components of the electronic apparatus 101 (e.g., the display device 160 or the camera module 180). Additionally or alternatively, the device management application may support the installation, deletion, or update of an application operating in an external electronic apparatus.

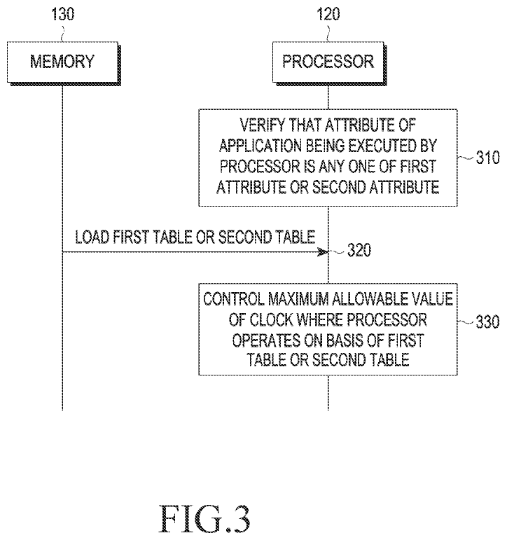

FIG. 3 is a flowchart showing that an electronic apparatus controls a maximum allowable value of a clock on which a processor operates in accordance with an attribute of an application, according to an embodiment.

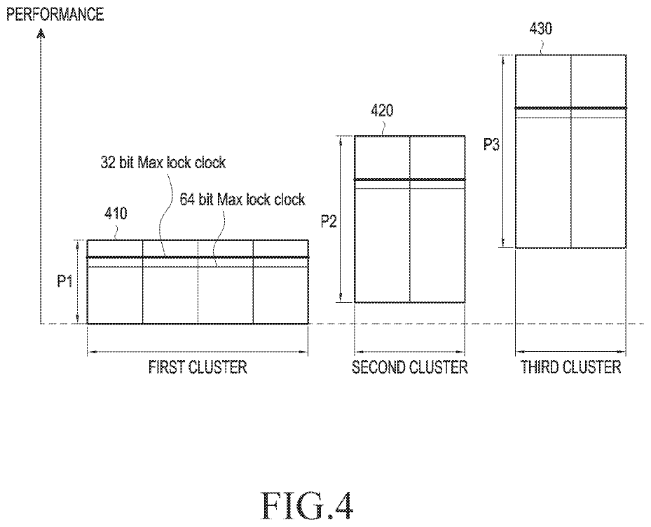

An electronic apparatus 101 may include a processor 120 and a memory 130. The processor 120 may be functionally connected to the memory 130 and may load data stored in the memory 130. The memory 130 may store a first table and a second table that are associated with a maximum allowable value of a clock on which the processor 120 operates. The first table and the second table may be selected according to an attribute of an application executed by the processor 120. The processor 120 may limit the maximum allowable value of the clock on which the processor 120 operates according to the first table and the second table, thereby preventing overload and overclock of the processor 120 and controlling heat generation of the processor 120. Details of the first table and the second table will be described in detail with reference to FIG. 4. The two tables are merely for illustration, and there is no restriction on the number of tables.

Referring to FIG. 3, in operation 310, the processor 120 verifies that an attribute of an application being executed by the processor 120 is either a first attribute or a second attribute. The processor 120 may identify the attribute of the application by identifying the instruction set architecture of the application. The instruction set architecture may refer to a machine language instruction that the processor can recognize to understand and execute a corresponding function. For example, the processor 120 may identify the instruction set architecture of the application, thereby identifying whether the application is an application of the first attribute having a 32-bit instruction set architecture or an application of the second attribute having a 64-bit instruction set architecture. Although the processor 120 may identify the attribute of the application operating in the foreground, there is no restriction on the type, execution location, or activity stack of an application of which an attribute is identified by the processor 120.

Even when the application being executed by the processor 120 is changed to a different application, an attribute of the different application may be identified. As the application being executed is changed to the different application, the processor 120 may identify that the attribute of the changed different application is the first attribute or the second attribute.

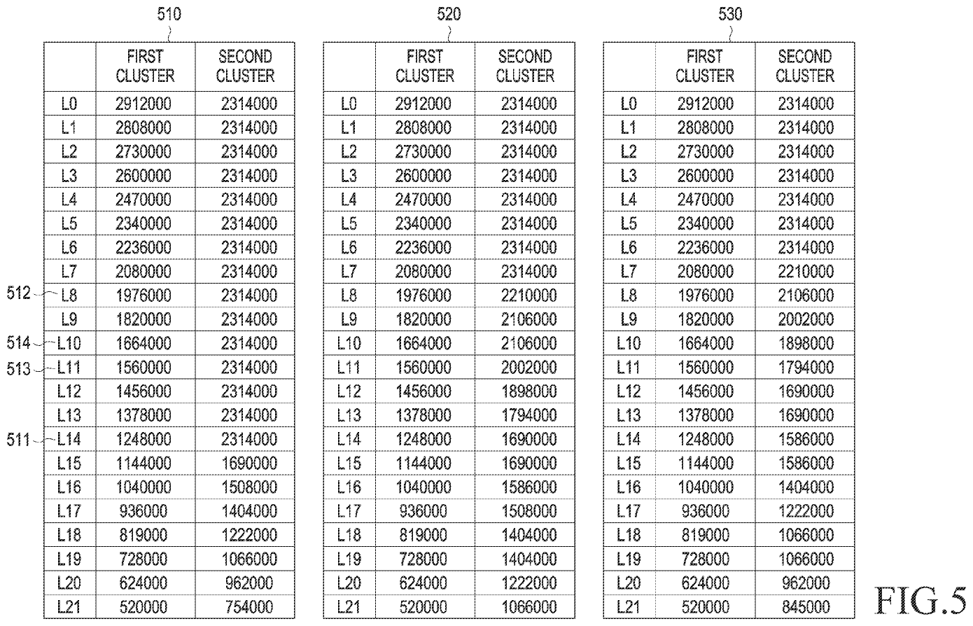

In operation 320, the processor 120 loads the first table or the second table associated with the maximum allowable value of the clock on which the processor 120 operates from the memory 130 according to the identified attribute of the application. For example, when the instruction set architecture of the application has the first attribute of 32 bits, the processor 120 may load the first table from the memory 130. When the instruction set architecture of the application has the second attribute of 64 bits, the processor 120 may load the second table from the memory 130. Operation 330 will be described later with reference to FIG. 5.

FIG. 4 illustrates a configuration in which a maximum allowable value of a clock of a processor is determined for each cluster, according to an embodiment. FIG. 5 illustrates a table of maximum allowable values of a clock on which a plurality of clusters operates, according to an embodiment.

Referring to FIG. 4, a processor 120 may include a plurality of cores. Each core may be a unit in which the processor 120 processes a task. At least some of the cores may have the same maximum performance. Alternatively, some of the cores may have a different maximum performance P1, P2, or P3 for processing a task. For example, each of the cores having different maximum performances may have a maximum performance of any one of P1, P2, and P3. The plurality of cores included in the processor 120 may be classified into at least one cluster according to maximum performance. For example, the processor 120 may include eight cores, and the eight cores may be classified into a first cluster 410, a second cluster 420, and a third cluster 430. The first cluster 410 may include four cores having the lowest maximum performance among the plurality of cores, and the third cluster 430 may include two cores having the highest performance among the plurality of cores. The processor 120 may configure and control a maximum allowable value of a clock on which each cluster operates, based on a heat generation level where each cluster executes an application or processes a task or the maximum performance of the cluster. Accordingly, as shown in FIG. 4, the maximum allowable value of the clock on which the cluster operates may be different for each cluster, and a table of the maximum allowable value on which each cluster operates may also be different for each cluster.

The maximum allowable value of the clock on which the cluster operates may be controlled based on the instruction set architecture of an application or task processed in each cluster. For example, in the first cluster 410 of FIG. 4, the maximum allowable value of the clock may be controlled based on 32 bits or 64 bits according to the instruction set architecture of an executed application or task. A maximum allowable clock value based on 32 bits may be configure to be greater than a maximum allowable clock value based on 64 bits.

FIG. 5 illustrates a table of maximum allowable values of a clock on which a plurality of clusters operates, according to an embodiment.

A memory 130 may store a table for a clock on which a processor 120 operates according to a performance-to-power consumption value. For example, the memory 130 may store a first table for the clock on which the processor 120 operates when an attribute of an application is a first attribute, and may store a second table for the clock on which the processor 120 operates when the attribute of the application is a second attribute. For at least some values, a maximum allowable value corresponding to the first table may be different from a maximum allowable value corresponding to the second table.

Referring to FIG. 5, the processor 120 may generate a table of maximum allowable values of a clock on which each of a plurality of clusters operates according to a power consumption value relative to the performance of the processor. A different maximum allowable value of the clock on which each cluster operates may be configured for each case in which the instruction set architecture of an application or task has 32 bits or 64 bits.

A first table 510 is an illustrative table of maximum allowable values of a clock uniformly configured without considering the instruction set architecture of an application or task. According to the first table 510, the maximum allowable values of the clock are configured without considering the instruction set architecture of the task, and the maximum allowable value of a clock on which a first cluster operates at an L14 value 511 is configured to be lower than a clock value corresponding to the maximum performance of the first cluster, and thus the processor 120 may inefficiently operate.

A second table 520 and a third table 530 are illustrative tables indicating maximum allowable values of a clock for each cluster for each of 32 bits or 64 bits in consideration of the instruction set architecture of an application. Regarding the second table 520 and the third table 530, the maximum allowable value of the operation clock for each cluster may be controlled in consideration of a heat generation level and the maximum performance of the first cluster and a second cluster. Therefore, the maximum allowable values of clocks for the first cluster and the second cluster at an L8 value 512, which are higher than that at the L14 value 511 may be controlled to improve the performance of the processor, thus enabling efficient task processing. For example, when an attribute of an application being executed is identified, the processor 120 may identify at least one of the heat generation level, the maximum performance, and the performance sustainability of the first cluster and the second cluster, and may configure a clock value corresponding to an L11 value 513 or an L12 value 514 within a range in which the first cluster and the second cluster have high performance as a maximum allowable clock value according to an identification result. However, the foregoing specific example is merely for illustration and does not limit the spirit of the disclosure.

Referring back to FIG. 3, in operation 330, the processor 120 controls the maximum allowable value of the clock on which the processor 120 operates, based on the first table or the second table. The maximum allowable value of the clock on which the processor 120 operates may include a maximum allowable value of a clock on which each of at least one cluster included in the processor 120 operates. In the following description, it is assumed that the maximum allowable value of the clock on which the processor 120 operates may include the maximum allowable value of the clock on which each of the at least one cluster included in the processor 120 operates. The processor 120 may control the maximum allowable value of the clock on which the processor 120 operates, based on the first table when the application has the first attribute, and may control the maximum allowable value of the clock on which the processor 120 operates, based on the second table when the application has the second attribute. The processor 120 may control a clock generator, thereby controlling the maximum allowable value of the clock on which the processor 120 operates. The clock generator may exist inside or outside the processor 120. The clock generator may be configured as an independent circuit, or may be configured as part of various types of hardware, such as a power management integrated circuit. The clock generator is not limited to the foregoing examples and may be configured in various manners.

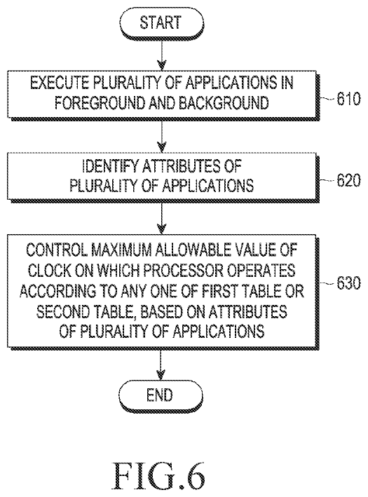

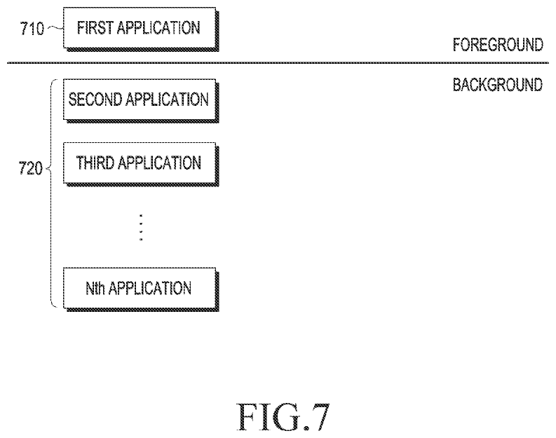

FIG. 6 is a flowchart illustrating a configuration in which an electronic apparatus controls a maximum allowable value of a clock on which a processor operates in accordance with attributes of a plurality of applications, according to an embodiment. FIG. 7 illustrates a configuration in which an electronic apparatus controls a maximum allowable value of a clock on which a processor operates in accordance with attributes of a plurality of applications, according to an embodiment.

Referring to FIG. 6, in operation 610, a processor 120 executes a plurality of applications in the foreground and the background.

Referring to FIG. 7, the processor 120 may execute a first application 710 in the foreground and executes at least one application 720 in the background. The foreground may collectively refer to an environment in which an application having a high priority is executed when a plurality of applications is executed. The application executed in the foreground is an application executed with the highest priority and may be an application displayed on a display 160 of an electronic apparatus 101. The background is an environment in which an application having a lower priority than that of an application executed in the foreground is executed when a plurality of applications is executed, and the application executed in the background is executed with a low priority and may not be displayed on the display 160 of the electronic apparatus 101.

In operation 620 of FIG. 6, the processor 120 identifies attributes of the plurality of applications.

Referring again to FIG. 7, the processor 120 may identify whether the first application 710 being executed in the foreground and the at least one application 720 being executed in the background have a first attribute or a second attribute. For example, the processor 120 may identify whether the instruction set architecture of the plurality of applications 710 and 720 has the first attribute having 32 bits or the second attribute having 64 bits.

In operation 630 of FIG. 6, the processor 120 controls a maximum allowable value of a clock on which the processor operates according to either a first table or a second table, based on the attributes of the plurality of applications.

The processor 120 may identify the number of at least one application having the first attribute and the number of at least one application having the second attribute, and may control the maximum allowable value of the clock on which the processor 120 operates, based on the identified numbers. For example, when the number of at least one application having 32-bit instruction set architecture and thus having the first attribute is greater than the number of at least one application having 64-bit instruction set architecture and thus having the second attribute, the processor 120 may control the maximum allowable value of the clock on which the processor 120 operates according to the first table corresponding to the 32-bit instruction set architecture. Alternatively, when the number of the at least one application having the first attribute is less than or equal to the number of the at least one application having the second attribute, the processor 120 may control the maximum allowable value of the clock on which the processor 120 operates according to the second table.

The processor 120 may identify the use ratio of the processor 120 between the at least one application having the first attribute and the at least one application having the second attribute, and may control the maximum allowable value of the clock on which the processor 120 operates, based on the identified use ratio of the processor 120. For example, when at least one application having 32-bit instruction set architecture and thus having the first attribute has a higher processor use ratio than that of at least one application having 64-bit instruction set architecture and thus having the second attribute, the processor 120 may control the maximum allowable value of the clock on which the processor 120 operates according to the first table corresponding to the 32-bit instruction set architecture. Alternatively, when the processor use ratio of the at least one application having the first attribute is lower than or equal to that of the at least one application having the second attribute, the processor 120 may control the maximum allowable value of the clock on which the processor 120 operates according to the second table.

The processor 120 may identify the number of at least one task processed per unit time by the processor 120 for the at least one application having the first attribute and that for the at least one application having the second attribute. The processor 120 may control the maximum allowable value of the clock on which the processor 120 operates based on the identified numbers of the at least one task. For example, when the number of tasks included in at least one application having 32-bit instruction set architecture and thus having the first attribute is greater than the number of tasks included in at least one application having the second attribute, the processor 120 may control the maximum allowable value of the clock on which the processor 120 operates according to the first table corresponding to 32 bits. Alternatively, when the number of tasks included in the at least one application having the first attribute is less than or equal to the number of tasks included in the at least one application having the second attribute, the processor 120 may control the maximum allowable value of the clock on which the processor 120 operates according to the second table corresponding to 64 bits.

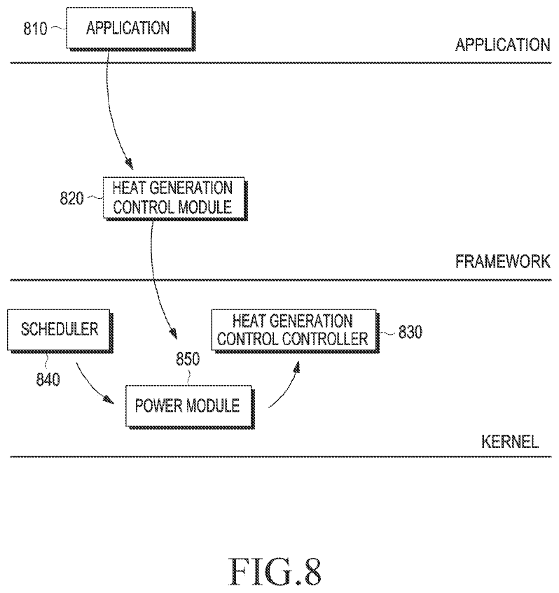

FIG. 8 is a block diagram illustrating a configuration in which heat generation control of a processor is performed in an application level, a framework level, and a kernel level, according to an embodiment.

Referring to FIG. 8, a processor 120 executes an application 810 in an application level. The processor 120 may identify an attribute of the application 810 being executed and may identify whether the instruction set architecture of the application is a first attribute having 32 bits or a second attribute having 64 bits. The processor 120 may transmit information associated with the identified attribute of the application 810 to a heat generation control module 820 in a framework level. The heat generation control module 820 may transmit the received information to a heat generation control controller 830 in a kernel level.

A scheduler 840 in the kernel level may identify not only the attribute of the application 810 currently being executed but also attributes of a plurality of tasks being executed by the processor 120, and may store a first table and a second table generated based on identified information in a power module 850. Upon receiving the information about the attribute of the application 810 from the heat generation control module 820, the heat generation control controller 830 may load the first table and the second table from the power module 850, may configure a maximum allowable value of a clock on which the processor 120 operates, based on the attribute of the application 810 and the attributes of the plurality of tasks, and may control the processor 120 according to the configured value. For example, as described with reference to FIG. 3 to FIG. 6, the heat generation control controller 830 may control the maximum allowable value of the clock on which the processor 120 operates according to the first table or the second table selected based on the attribute of the application 810 and the attributes of the plurality of tasks.

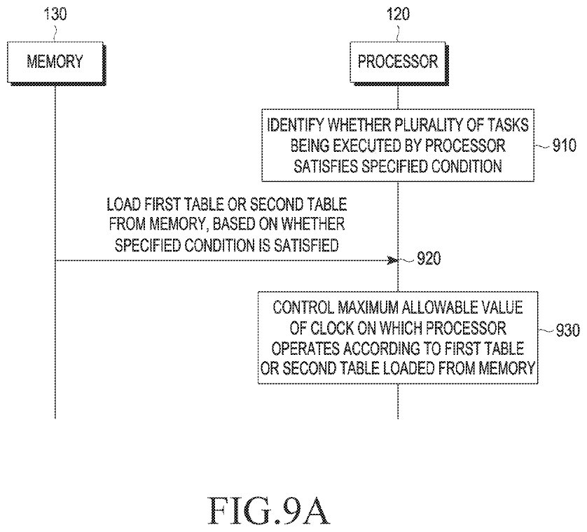

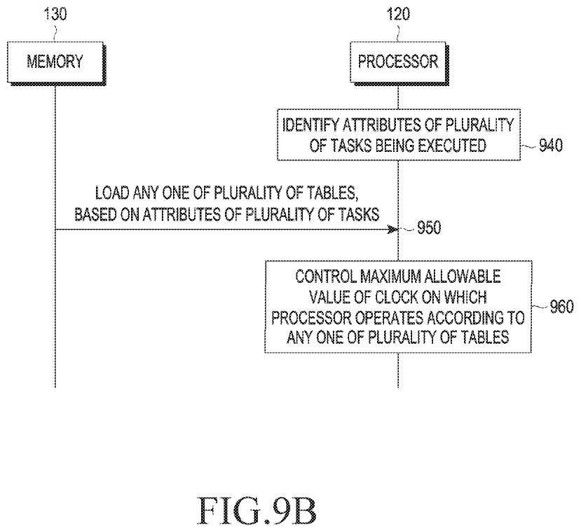

FIG. 9A is a flowchart showing that an electronic apparatus controls a maximum allowable value of a clock on which a processor operates in accordance with an attribute of an application, according to an embodiment.

An electronic apparatus 101 may include a processor 120 and a memory 130. The memory 130 may store a first table and a second table associated with a maximum allowable value of a clock on which a processor 120 operates.

Referring to FIG. 9A, in operation 910, the processor 120 identifies whether a plurality of tasks being executed by the processor 120 satisfies a specified condition. The processor 120 may execute the plurality of tasks. The plurality of tasks may correspond to respective functions performed in at least one application. The least one application may be executed by the processor 120 in the foreground and the background. The processor 120 may identify whether the plurality of tasks satisfies the specified condition, based on any one of the number of at least one task having a first attribute and at least one task having a second attribute among the plurality of tasks and the processor use ratio. In operation 920, the processor 120 loads the first table or the second table from the memory 130, based on whether the specified condition is satisfied. The processor 120 may load the first table from the memory 130 when the plurality of tasks satisfies the specified condition, and may load the second table from the memory 130 when the plurality of tasks does not satisfy the specified condition.

In operation 930, the processor 120 controls a maximum allowable value of a clock on which the processor 120 operates according to the first table or the second table loaded from the memory 130. The processor 120 may control the maximum allowable value of the clock on which the processor 120 operates according to the first table corresponding to 32-bit instruction set architecture or the second table corresponding to 64-bit instruction set architecture.

FIG. 9B is a flowchart showing that an electronic apparatus determines a maximum allowable value of a clock on which a processor operates, based on attributes of a plurality of tasks, according to an embodiment.

In operation 940, a processor 120 identifies attributes of a plurality of tasks being executed by the processor 120. For example, the processor 120 may identify the instruction set architecture of the plurality of tasks and may identify whether the instruction set architecture of the plurality of tasks corresponds to 32 bits or 64 bits. When any one task of the instruction set architecture of the plurality of tasks corresponds to 32 bits, the processor 120 may determine that the task has a first attribute, and when the task corresponds to 64 bits, the processor 120 may determine that the task has a second attribute.

In operation 950, the processor 120 loads any one of a plurality of tables from a memory, based on the attributes of the plurality of tasks. The memory 130 may store the plurality of tables associated with a maximum allowable value of a clock on which the processor 120 operates. The plurality of tables may include, in addition to the second table 520 corresponding to the first attribute of FIG. 5 and the third table 530 corresponding to the second attribute of FIG. 5, tables having maximum allowable values between the second table 520 and the third table 530. The memory 130 may select an appropriate table based on various conditions, such as the use ratio of the processor 120, using various tables in addition to the second table 520 and the third table 530 of FIG. 5 in a situation in which the processor 120 executes the plurality of tasks, thereby increasing the task processing performance of the processor 120.

The processor 120 may identify the use ratio of the processor 120 between at least one task having the first attribute and at least one task having the second attribute and may load any one table of the plurality of tables from the memory 130 according to the identified use ratio. For example, when the use ratio of the processor 120 between the at least one task having the first attribute and the at least one task having the second attribute is 50:50, the processor 120 may select and load a table having an intermediate value between the first table 520 and the second table 530. Alternatively, the processor 120 may identify the number of at least one task processed per unit time by the processor 120 for the at least one task having the first attribute and that for the at least one task having the second attribute and may load any one table of the plurality of tables, based on the identified numbers. For example, when the numbers of the at least one task processed per unit time by the processor 120 for the at least one task having the first attribute and for the at least one task having the second attribute are the same, the processor 120 may select and load a table having an intermediate value between the first table 520 and the second table 530.

In operation 960, the processor 120 controls the maximum allowable value of the clock on which the processor 120 operates according to any one of the plurality of tables. The processor 120 may control the maximum allowable value of the clock on which the processor 120 operates, based on the table loaded from the memory 130, thereby increasing the task processing performance of the processor 120. The processor 120 may use a greater number of tables than the electronic apparatus of FIG. 9A that controls the maximum allowable value of the clock using two tables, thereby selecting a table to maximize the performance of the processor 120 based on the current state of the processor 120.

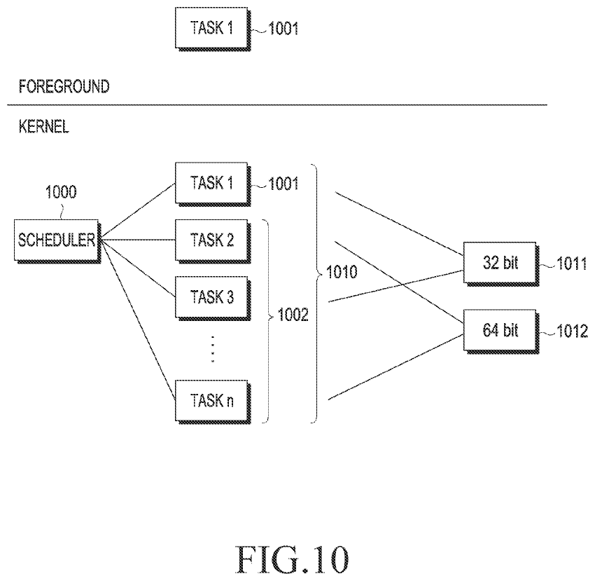

FIG. 10 illustrates a configuration in which an electronic apparatus determines a maximum allowable value of a clock on which a processor operates, based on attributes of a plurality of tasks, according to various embodiments.

Referring to FIG. 10, a processor 120 may execute a plurality of tasks 1010. The processor 120 may execute a first task 1001 in the foreground and may execute tasks 1002 excluding the first task 1001 in the background. A scheduler 1000 in a kernel level may classify the plurality of tasks 1010 according to attributes of the plurality of tasks 1010. For example, the scheduler 1000 may identify whether the plurality of tasks 1010 has an instruction set architecture of 32 bits 1011 or an instruction set architecture of 64 bits 1012 and may classify the plurality of tasks 1010 according to the identified attributes.

Referring to FIG. 9A, the processor 120 may load a first table or a second table from a memory 130 according to the identified attributes of the plurality of tasks 1010. The processor 120 may control a maximum allowable value of a clock on which the processor 120 operates according to the first table or the second table loaded from the memory 130. Since various examples of a configuration of selecting the first table or the second table have been described in detail, a description thereof is omitted. The processor 120 may control the maximum allowable value of the clock on which the processor 120 operates according to the first table corresponding to the 32-bit instruction set architecture or the second table corresponding to the 64-bit instruction set architecture. Alternatively, referring to FIG. 9B, the processor 120 may load any one of a plurality of tables according to the identified attributes of the plurality of tasks 1010 and may control the maximum allowable value of the clock on which the processor 120 operates according to the loaded table. Compared to FIG. 9A, the processor 120 of FIG. 9B may select one table from among a greater number of tables and may control the maximum allowable value of the clock according to the selected table.

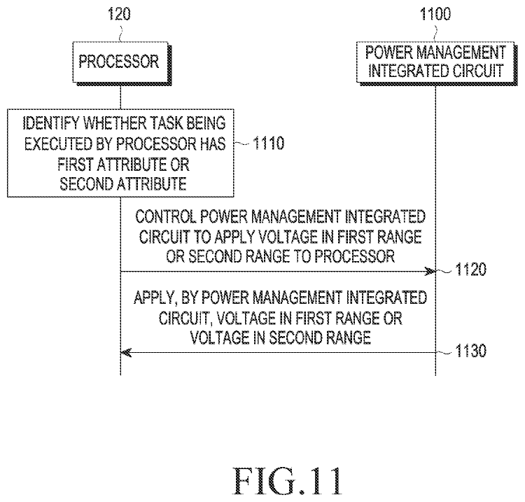

FIG. 11 is a flowchart illustrating a configuration in which an electronic apparatus controls the range of a voltage applied to a processor based on an attribute of a task, according to an embodiment.

An electronic apparatus 101 includes a processor 120 and a power management integrated circuit 1100. The power management integrated circuit 1100 may receive power from a battery 189 and may provide the received power to the processor 120.

In operation 1110, the processor 120 identifies whether a task being executed by the processor 120 has a first attribute or a second attribute. For example, the processor 120 may identify the instruction set architecture of the task and may identify whether the instruction set architecture of the task has the first attribute of 32 bits or the second attribute of 64 bits, based on the identified instruction set architecture.

In operation 1120, the processor 120 controls the power management integrated circuit 1100 to apply a voltage in a first range or a second range to the processor 120. In operation 1130, the power management integrated circuit 1100 applies a voltage in the first range or a voltage in the second range. For example, when the task has the first attribute, the processor 120 may control the power management integrated circuit 1100 to apply the voltage in the first range to the processor 120. When the task has the second attribute, the processor 120 may control the power management integrated circuit 1100 to apply the voltage in the second range to the processor 120. The voltage in the first range and the voltage in the second range may have respective maximum values corresponding to overclock of the processor 120, and the maximum value corresponding to the voltage in the first range and the maximum value corresponding to the voltage in the second range may be different. For example, the maximum value corresponding to the voltage in the first range may be greater than the maximum value corresponding to the voltage in the second range.

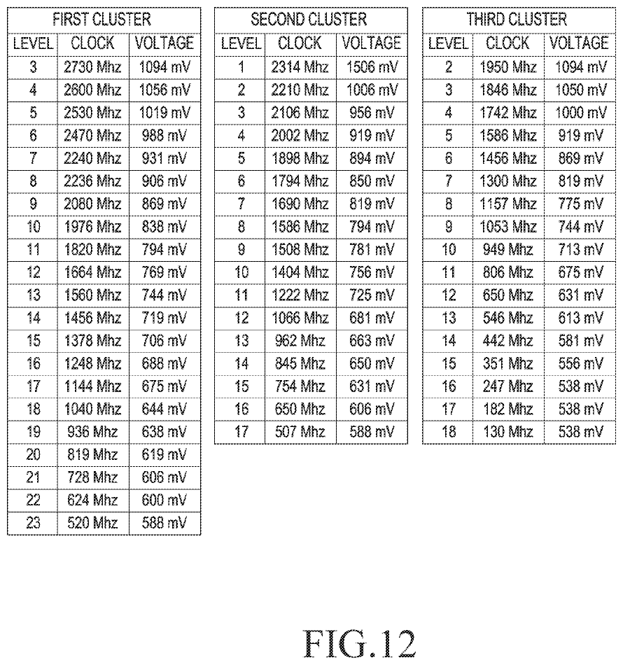

FIG. 12 illustrates a table used by an electronic apparatus to control the range of a voltage applied to a processor, based on an attribute of a task, according to an embodiment.

As described above, a plurality of cores included in a processor 120 may be classified into at least one cluster. For example, the processor 120 may include a first cluster, a second cluster, and a third cluster. The first cluster may be a cluster having the highest maximum performance among the at least one cluster, and the third cluster may be a cluster having the lowest maximum performance among the at least one cluster. The processor 120 may control a power management integrated circuit to apply voltages in different ranges to the at least one cluster, based on at least one of the performance or heat generation level of each cluster.

A first table 1210, a second table 1220, and a third table 1230 are tables of voltage values for the first cluster, the second cluster, and the third cluster at which the processor 120 operates at a maximum allowable value of a clock corresponding to each level. The third cluster having the lowest maximum performance may not operate with a clock exceeding 1950 megahertz (MHz), and the first cluster having the highest maximum performance may operate with a clock having the highest maximum allowable value. Therefore, as illustrated in FIG. 12, since the first cluster, the second cluster, and the third cluster have different maximum allowable values of the clock, voltages in different ranges corresponding to the maximum allowable values of the clock may be applied. For example, the range of a voltage applied to the first cluster may be wider than the range of a voltage applied to the second cluster and the range of a voltage applied to the third cluster, and the range of the voltage applied to the second cluster may be wider than the range of the voltage applied to the third cluster.

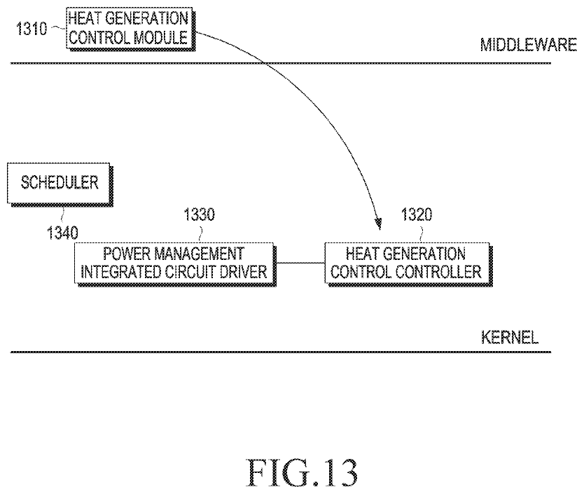

FIG. 13 illustrates a configuration in which heat generation control of an electronic apparatus is performed in middleware and kernel levels, according to an embodiment.

Referring to FIG. 13, a heat generation control module 1310 in the middleware level and a scheduler 1340 in the kernel level may identify an attribute of a task being executed in the foreground. The heat generation control module 1310 and the scheduler 1340 may identity the attribute of the task by identifying whether the task has a 32-bit instruction set architecture or a 64-bit instruction set architecture, based on the instruction set architecture of the task being executed. A heat generation control controller 1320 of the kernel may receive information about the attribute of the task from the heat generation control module 1310, and may control a power management integrated circuit driver 1330, based on the attribute of the task. The heat generation control controller 1320 may control the power management integrated circuit driver 1330 to apply a voltage in a first range to a processor 120 when the task has the 32-bit instruction set architecture and thus has a first attribute, and may control the power management integrated circuit driver 1330 to apply a voltage in a second range to the processor 120 when the task has the 64-bit instruction set architecture and thus has a second attribute, thereby enabling the power management integrated circuit driver 1330 to apply the voltage in the first range or the second range to the processor 120.

An electronic apparatus may include at least one processor and a memory storing a first table and a second table that are associated with performance-related values and a maximum allowable value of a clock on which the at least one processor operates, wherein a maximum allowable value in the first table corresponding to at least some of the performance-related values on which the at least one processor operates is different from a maximum allowable value in the second table corresponding to the at least some of the performance-related values, wherein the at least one processor may: identify that an attribute of an application being executed by the at least one processor is either a first attribute or a second attribute; and control a power management integrated circuit to control the maximum allowable value of the clock on which the at least one processor operates, based on the first table when the attribute of the application is the first attribute and to control the maximum allowable value of the clock on which the at least one processor operates, based on the second table when the attribute of the application is the second attribute.

The at least one processor may identify the instruction set architecture of the application being executed by the at least one processor; and identify that the attribute of the application is either the first attribute or the second attribute, based on the instruction set architecture of the application. The at least one processor may identify that the application being executed by the at least one processor is changed to a different application; and control a maximum allowable clock of the at least one processor according to either the first table or the second table, based on an attribute of the different application. The at least one processor may control the maximum allowable value of the clock on which the at least one processor operates according to either the first table or the second table, based on the attribute of the application being executed in the foreground and an attribute of at least one application being executed in the background. The at least one processor may identify the number of at least one application having the first attribute and at least one application having the second attribute; and control the maximum allowable value of the clock on which the at least one processor operates according to either the first table or the second table, based on the identified number.

The at least one processor may identify the use ratio of the at least one processor between at least one application having the first attribute and at least one application having the second attribute; and control the maximum allowable value of the clock on which the at least one processor operates according to either the first table or the second table, based on the use ratio. The at least one processor may identify the number of at least one task processed per unit time by the at least one processor for at least one application having the first attribute and at least one application having the second attribute; and control the maximum allowable value of the clock on which the at least one processor operates according to either the first table or the second table, based on the identified number of the at least one task. The at least one processor may include a plurality of cores classified into at least one cluster; and configure a maximum allowable value of each clock on which the at least one cluster operates, based on at least one of performance or a heat generation level of each cluster.

An electronic apparatus may include at least one processor and a memory storing a plurality of tables associated with performance-related values and a maximum allowable value of a clock on which the at least one processor operates. Maximum allowable values respectively included in the plurality of tables corresponding to at least some of the performance-related values on which the at least one processor operates may be different from each other. The at least one processor may identify an attribute of a plurality of tasks being executed by the at least one processor; and control the maximum allowable value of the clock on which the at least one processor operates according to a first table among the plurality of tables, based on the attribute of the plurality of tasks.

The at least one processor may identify the instruction set architecture of the plurality of tasks; and identify the attribute of the plurality of tasks, based on the instruction set architecture. The at least one processor 120 may identify the number of at least one task having the first attribute among the plurality of tasks and the number of at least one task having the second attribute; and select the first table among the plurality of tables, based on the ratio between the number of the at least one task having the first attribute and the number of the at least one task having the second attribute.

The at least one processor may identify the use ratio of the at least one processor between at least one task having the first attribute among the plurality of tasks and at least one task having the second attribute; and select the first table among the plurality of tables, based on the use ratio.

The at least one processor may identify the number of tasks processed per unit time by the at least one processor for at least one task having the first attribute among the plurality of tasks and at least one task having the second attribute; and select the first table among the plurality of tables, based on the number of tasks. The at least one processor may include a plurality of cores classified into at least one cluster; and configure a maximum allowable value of each clock on which the at least one cluster operates, based on at least one of performance or a heat generation level of each cluster.

An electronic apparatus may include at least one processor and a power management integrated circuit, wherein the at least one processor may be configured to identify whether a task being executed by the at least one processor has a first attribute or a second attribute; control the power management integrated circuit so that the power management integrated circuit applies a voltage in a first range to the at least one processor when the task has the first attribute; and control the power management integrated circuit so that the power management integrated circuit applies a voltage in a second range to the at least one processor when the task has the second attribute.

In the electronic apparatus, a maximum value of the voltage in the first range associated with overclock of the at least one processor is different from a maximum value of the voltage in the second range associated with the overclock of the at least one processor. The at least one processor may identify the instruction set architecture of the task; and identify that the attribute of the task is either the first attribute or the second attribute, based on the instruction set architecture of the task. The at least one processor may identify the task being executed by the at least one processor is changed to a different task; and control the power management integrated circuit so that the power management integrated circuit applies the voltage in the first range or the voltage in the second range to the at least one processor, based on an attribute of the changed task.

The at least one as processor may include a plurality of cores classified into at least one cluster; and control the power management integrated circuit to apply voltages in different ranges to the at least one cluster, based on at least one of performance or a heat generation level of each cluster. The at least one as processor may control the power management integrated circuit so that the power management integrated circuit applies either the voltage in the first range or the voltage in the second range to the at least one processor, based on the attribute of the task being executed in the foreground and an attribute of at least one task being executed in the background.

The electronic device 101 according to various embodiments may be one of various types of electronic devices. The electronic device 101 may include, for example, a portable communication device (e.g., a smartphone), a computer device, a portable multimedia device, a portable medical device, a camera, a wearable device, or a home appliance. According to an embodiment of the disclosure, the electronic device 101 is not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., a program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

A method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

According to various embodiments, a clock of a processor may be controlled in consideration of the instruction set architecture of an application or a task, thereby enabling efficient heat generation control for each instruction set architecture of an application or a task and thus achieving sustainable performance.

While the present disclosure has been particularly shown and described with reference to certain embodiments thereof, it will be understood by those of ordinary skill in the art that various changes in form and details may be made therein without departing from the spirit and scope of the disclosure as defined by the appended claims and their equivalents.

1. An electronic apparatus comprising:
at least one processor; and
a memory storing a first table and a second table that are associated with performance-related values and a maximum allowable value of a clock on which the at least one processor operates,
wherein a maximum allowable value in the first table corresponding to at least some of the performance-related values on which the at least one processor operates is different from a maximum allowable value in the second table corresponding to the at least some of the performance-related values, and
wherein the at least one processor is configured to:
identify that an attribute of an application being executed by the at least one processor is either a first attribute or a second attribute;
control the maximum allowable value of the clock on which the at least one processor operates, based on the first table when the attribute of the application is the first attribute; and
control the maximum allowable value of the clock on which the at least one processor operates, based on the second table when the attribute of the application is the second attribute.

2. The electronic apparatus of claim 1, wherein the at least one processor is further configured to:
identify an instruction set architecture of the application being executed by the at least one processor; and
identify that the attribute of the application is either the first attribute or the second attribute, based on the instruction set architecture of the application.

3. The electronic apparatus of claim 2, wherein the at least one processor is further configured to:
identify that the application being executed by the at least one processor is changed to a different application; and
control a maximum allowable clock of the at least one processor according to either the first table or the second table, based on an attribute of the different application.

4. The electronic apparatus of claim 1, wherein the at least one processor is further configured to control the maximum allowable value of the clock on which the at least one processor operates according to either the first table or the second table, based on the attribute of the application being executed in a foreground and an attribute of at least one application being executed in a background.

5. The electronic apparatus of claim 4, wherein the at least one processor is further configured to:
identify a number of at least one application having the first attribute and at least one application having the second attribute; and
control the maximum allowable value of the clock on which the at least one processor operates according to either the first table or the second table, based on the identified number.

6. The electronic apparatus of claim 4, wherein the at least one processor is further configured to:
identify a use ratio of the at least one processor between at least one application having the first attribute and at least one application having the second attribute; and
control the maximum allowable value of the clock on which the at least one processor operates according to either the first table or the second table, based on the use ratio.

7. The electronic apparatus of claim 4, wherein the at least one processor is further configured to:
identify a number of at least one task processed per unit time by the at least one processor for at least one application having the first attribute and at least one application having the second attribute; and
control the maximum allowable value of the clock on which the at least one processor operates according to either the first table or the second table, based on the identified number of the at least one task.

8. The electronic apparatus of claim 1, wherein the at least one processor is further configured to:
comprise a plurality of cores classified into at least one cluster; and
configure a maximum allowable value of each clock on which the at least one cluster operates, based on at least one of performance or a heat generation level of each cluster.

9. The electronic apparatus of claim 1, wherein, when the memory stores a plurality of tables associated with the performance-related values and the maximum allowable value of the clock on which the at least one processor operates,
the at least one processor is further configured to:
identify an attribute of a plurality of tasks being executed by the at least one processor; and
control the maximum allowable value of the clock on which the at least one processor operates according to any one table of the plurality of tables, based on the attribute of the plurality of tasks.

10. The electronic apparatus of claim 9, wherein the at least one processor is further configured to:
identify a number of at least one task having the first attribute among the plurality of tasks and a number of at least one task having the second attribute; and
select the one table among the plurality of tables, based on a ratio between the number of the at least one task having the first attribute and the number of the at least one task having the second attribute.

11. The electronic apparatus of claim 1, further comprising:
a power management integrated circuit,
wherein the at least one processor is further configured to:
identify whether a task being executed by the at least one processor has the first attribute or the second attribute;
control the power management integrated circuit so that the power management integrated circuit applies a voltage in a first range to the at least one processor when the task has the first attribute; and
control the power management integrated circuit so that the power management integrated circuit applies a voltage in a second range to the at least one processor when the task has the second attribute.

12. The electronic apparatus of claim 11, wherein a maximum value of the voltage in the first range associated with overclock of the at least one processor is different from a maximum value of the voltage in the second range associated with the overclock of the at least one processor.

13. The electronic apparatus of claim 11, wherein the at least one processor is further configured to:
comprise a plurality of cores classified into at least one cluster; and
control the power management integrated circuit to apply voltages in different ranges to the at least one cluster, based on at least one of performance or a heat generation level of each cluster.

14. A method for performing heat generation control by an electronic apparatus, the method comprising:
storing a first table and a second table that are associated with performance-related values and a maximum allowable value of a clock on which at least one processor of the electronic apparatus operates, wherein a maximum allowable value in the first table corresponding to at least some of the performance-related values on which the at least one processor operates is different from a maximum allowable value in the second table corresponding to the at least some of the performance-related values;
identifying that an attribute of an application being executed by the at least one processor is either a first attribute or a second attribute;
controlling the maximum allowable value of the clock on which the at least one processor operates, based on the first table when the attribute of the application is the first attribute; and
controlling the maximum allowable value of the clock on which the at least one processor operates, based on the second table when the attribute of the application is the second attribute.

15. The method of claim 14, wherein the identifying that the attribute of the application being executed by the at least one processor is either the first attribute or the second attribute comprises:
identifying an instruction set architecture of the application being executed by the at least one processor; and
identifying that the attribute of the application is either the first attribute or the second attribute, based on the instruction set architecture of the application.

16. The method of claim 15, wherein identifying that the attribute of the application being executed by the at least one processor is either the first attribute or the second attribute further comprises:
identifying that the application being executed by the at least one processor is changed to a different application; and
controlling a maximum allowable clock of the at least one processor according to either the first table or the second table, based on an attribute of the different application.

17. The method of claim 14, wherein the method further comprises:
controlling the maximum allowable value of the clock on which the at least one processor operates according to either the first table or the second table, based on the attribute of the application being executed in a foreground and an attribute of at least one application being executed in a background.

18. The method of claim 14, wherein the at least one processor comprises a plurality of cores classified into at least one cluster, and
wherein the method further comprises:
configuring a maximum allowable value of each clock on which the at least one cluster operates, based on at least one of performance or a heat generation level of each cluster.

19. The method of claim 14, wherein, when a memory stores a plurality of tables associated with the performance-related values and the maximum allowable value of the clock on which the at least one processor operates, the method further comprises:
identifying an attribute of a plurality of tasks being executed by the at least one processor; and
controlling the maximum allowable value of the clock on which the at least one processor operates according to any one table of the plurality of tables, based on the attribute of the plurality of tasks.

20. The method of claim 14, wherein the method further comprises:
identifying whether a task being executed by the at least one processor has the first attribute or the second attribute;
applying a voltage in a first range to the at least one processor when the task has the first attribute; and
applying a voltage in a second range to the at least one processor when the task has the second attribute.
